(19) United States
(12) Patent Application Publication
(10) Pub. No.: US 2024/0269852 A1
(43) Pub. Date: Aug. 15, 2024

(54) PART MANIPULATOR FOR ASSEMBLY MACHINE

(71) Applicants: TE Connectivity Solutions GmbH, Schaffhausen (CH); Tyco Electronics (Shanghai) Co., Ltd., Shanghai (CN)

(72) Inventors: Sonny O. Osunkwo, Harrisburg, PA (US); Pablo Plascencia, Middletown, PA (US); Xianghao Bao, Shanghai (CN); Kellen Haile, Middletown, PA (US); Roberto Francisco-Yi Lu, Bellevue, WA (US); Swapnilsinh Solanki, Harrisburg, PA (US); Du Wen, Reading, PA (US); Lei Zhou, Shanghai (CN); Dongfang Zong, Shanghai (CN)

(21) Appl. No.: 18/326,114

(22) Filed: May 31, 2023

(30) Foreign Application Priority Data
Feb. 15, 2023 (CN) 202310165184.6

(51) Int. Cl. B25J 9/16; B25J 15/00

(52) U.S. Cl. CPC B25J 9/1687; B25J 9/1669; B25J 9/1697; B25J 15/009; B25J 15/0095

(57) ABSTRACT

A part manipulator includes a robot arm movable between a pick station and a place station. The part manipulator includes an end effector coupled to a distal end of the robot arm. The end effector includes a part support fixture and a pin gripper adjacent the part support fixture. The pin gripper includes a pin member and a pin actuator operated to move the pin member between a retracted position and an extended position. A distal end of the pin member extends from the part support fixture in the extended position to engage and hold a part against the part support fixture in the extended position. The pin member is configured to pick up the part in the extended position at the pick station. The pin actuator is configured to release the part at the place station when the pin member is moved to the retracted position.

### CROSS REFERENCE TO RELATED APPLICATIONS

This application claims benefit to Chinese Application No. 202310165184.6, filed 15 Feb. 2023, the subject matter of which is herein incorporated by reference in its entirety.

### BACKGROUND OF THE INVENTION

The subject matter herein relates generally to part assembly machines.

Part assembly machines are used to assemble parts into products using machine building processes rather than manual, hand building processes. Part assembly machines reduce assembly time and cost. Conventional part assembly machines use finger grippers to pick up parts. However, the compression by the finger grippers may damage some parts during the pick and place process. For example, ductile parts are susceptible to damage by finger grippers. Additionally, the finger grippers may deform the ductile parts when compressed, leading to difficulty in correctly inserting the part into an assembly.

A need remains for a part assembly machine that may pick and place ductile parts into an assembly, such as in scenarios where high part placement repeatability is needed and where there is a need to avoid damaging the ductile part.

### BRIEF DESCRIPTION OF THE INVENTION

In one embodiment, a part manipulator is provided and includes a robot arm being movable in three-dimensional space. The robot arm is movable between a pick station and a place station. The part manipulator includes an end effector coupled to a distal end of the robot arm. The end effector includes a part support fixture and a pin gripper adjacent the part support fixture. The pin gripper includes a pin member and a pin actuator operated to move the pin member between a retracted position and an extended position. A distal end of the pin member extends from the part support fixture in the extended position to engage and hold a part against the part support fixture in the extended position. The pin member is configured to pick up the part in the extended position at the pick station. The pin actuator is configured to release the part at the place station when the pin member is moved to the retracted position.

In another embodiment, a part assembly machine is provided and includes a pick station having a part feeder. The part feeder has a platform supporting parts. The part assembly machine includes a vision inspection station positioned adjacent the part feeder. The vision inspection station includes an imaging device to image the parts in a field of view above the platform. The part assembly machine includes a controller receiving images from the imaging device. The controller determines orientations of the parts on the platform from a plurality of possible orientations. The possible orientations include a picking orientation. The controller determines locations of each part in the picking orientation. The part assembly machine includes a part manipulator positioned adjacent the pick station to successively pick up the parts in the picking orientation from the part feeder. The part manipulator configured to place the parts at a place station. The part manipulator includes a robot arm and an end effector coupled to a distal end of the robot arm. The robot arm operably coupled to the controller. The robot arm is movable in three-dimensional space between the pick station and the place station. The end effector operably coupled to the controller. The end effector includes a part support fixture and a pin gripper adjacent the part support fixture. The pin gripper includes a pin member and a pin actuator operated to move the pin member between a retracted position and an extended position, a distal end of the pin member extends from the part support fixture in the extended position to engage and hold a part against the part support fixture in the extended position. The controller operates the robot arm to successively position the end effector proximate to the parts in the picking orientations. The controller operates the end effector to pick up the corresponding part in the picking orientation at the pick station with the pin member in the extended position. The controller operates the robot arm to move the end effector to the place station after the part is picked up. The controller operates the end effector to release the part at the place station when the pin member is moved to the retracted position.

In a further embodiment, a method of assembling parts is provided and includes loading the parts on an upper surface of a platform of a part feeder. The method images the parts on the platform using an imaging device. The method processes images to determine orientations of the parts on the platform from a plurality of possible orientations. The possible orientations include a picking orientation. The controller determines locations of each part in the picking orientation. The method successively picks up the parts that are in the picking orientation using a part manipulator includes a robot arm is movable in three-dimensional space and an end effector coupled to a distal end of the robot arm that includes a part support fixture and a pin gripper adjacent the part support fixture. The pin gripper includes a pin member and a pin actuator operated to move the pin member between a retracted position and an extended position, a distal end of the pin member extends from the part support fixture in the extended position to engage and hold a part against the part support fixture in the extended position. The method operates the robot arm to move the end effector and the part to a place station and operates the pin actuator to move the pin member to the retracted position to release the part at the place station.

### BRIEF DESCRIPTION OF THE DRAWINGS

FIG. 1 is a schematic illustration of a part assembly machine for assembling parts, such as parts used to form electrical connector in accordance with an exemplary embodiment.

FIG. 2 is a top view of the part assembly machine in accordance with an exemplary embodiment.

FIG. 3 is a perspective view of the part assembly machine in accordance with an exemplary embodiment showing a plurality of the parts on the parts feeder.

FIG. 4 is a perspective view of the part assembly machine in accordance with an exemplary embodiment showing the part manipulator loading the part into a connector housing of an electrical connector.

FIG. 5 illustrates an example of the part in the picking orientation (for example, face-up or face-down) in accordance with an exemplary embodiment.

FIG. 6 is a top perspective view of the part loaded into the connector housing in accordance with an exemplary embodiment.

FIG. 7 is a front view of a portion of the part manipulator in accordance with an exemplary embodiment.

FIG. 8 is a side view of a portion of the part manipulator in accordance with an exemplary embodiment.

FIG. 9 is a front view of a portion of the part manipulator in accordance with an exemplary embodiment.

FIG. 10 is a side view of a portion of the part manipulator in accordance with an exemplary embodiment.

FIG. 11 is a flow chart showing a method of assembling parts in accordance with an exemplary embodiment.

### DETAILED DESCRIPTION OF THE INVENTION

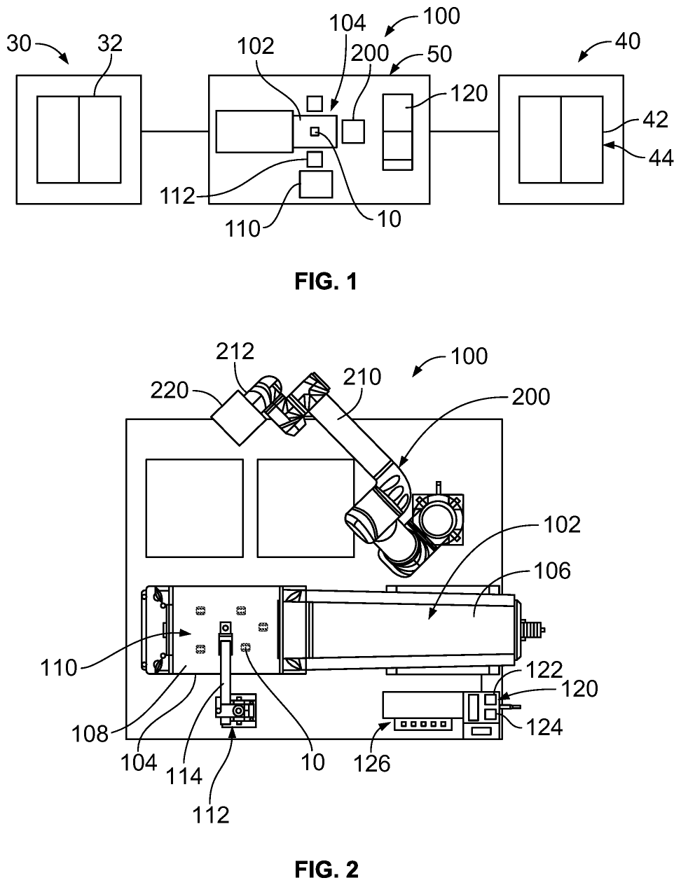

FIG. 1 is a schematic illustration of a part assembly machine 100 for assembling parts 10, such as parts used to form electrical connectors. For example, the parts 10 may be contacts, housings, gaskets, grommets, circuit boards, or other types of parts. In an exemplary embodiment, the parts 10 may be ductile parts, such as polymer parts, rubber parts, and the like. The parts 10 may be deformable.

The part assembly machine 100 may be used for assembling products used in other industries. The part assembly machine 100 includes one or more forming machines 30 at a forming station 32 used to form various parts 10. For example, the forming machines 30 may include a molding machine, a press, a lathe, and the like. The part assembly machine 100 includes one or more processing machines 40 at a processing station 42 used for processing the various parts 10. For example, the processing station 42 may include an assembly station, a part loading station, a part termination station, a part packaging station, and the like. The processing machine defines a place station 44 for placing the part 10, such as in another product, on another product, or in a package.

The part assembly machine 100 includes a part feeder 102 that supports the parts 10, such as for transport and/or inspection between the forming machine 30 and the processing machine 40. The part feeder 102 is used to feed or move the parts 10 through the part assembly machine 100. In an exemplary embodiment, the parts 10 may be loaded onto the part feeder 102 in any random orientation (for example, facing forward, facing rearward, facing sideways, facing upward, facing downward, and the like). The part assembly machine 100 is able to support the parts without the need for fixturing, which increases the throughput of the parts 10 through the part assembly machine 100. The parts 10 are picked up from the part feeder 102. As such, the part feeder 102 defines a pick station 50, at which the parts are picked.

In an exemplary embodiment, the part assembly machine 100 includes a vision inspection station 110 having one or more imaging devices 112 that image the parts 10 on the part feeder 102 and/or at the place station 44 within a field of view of the imaging device(s) 112. In the illustrated embodiment, the vision inspection station 110 includes multiple imaging devices 112 for imaging different sides of the parts 10. The imaging device 112 is able to image the parts 10 in the random orientations. In an exemplary embodiment, the vision inspection station 110 may be used to inspect different types of parts 10. For example, the vision inspection station 110 may be used to inspect different sized parts, different shaped parts, parts in different orientations, and the like.

In an exemplary embodiment, the part assembly machine 100 includes a controller(s) 120 for controlling operation of the various components of the part assembly machine 100. The controller 120 receives the images from the imaging device 112 and processes the images to determine inspection results. For example, the controller 120 determines the orientations of each of the parts 10 on the parts feeder 102. The controller 120 may inspect the parts, such as for quality and may reject parts that are defective. In an exemplary embodiment, the controller 120 includes a shape recognition tool configured to determine the orientations of the parts 10 in the field of view. The images may be processed by performing pattern recognition of the images based on an image analysis model. The shape recognition tool may compare shapes, patterns or features in the images to shapes, patterns or features in the image analysis model. The images may be processed by performing feature extraction of boundaries and surfaces detected in the images and comparing the boundaries and surfaces to the image analysis model. The controller 120 may identify lines, edges, bridges, grooves, or other boundaries or surfaces within the image. The processing of the images may provide image contrast enhancement for improved boundary or surface identification. In an exemplary embodiment, the controller 120 includes an artificial intelligence (AI) learning module used to customize and configure image analysis based on the images received from the imaging device 112. The controller 120 may be updated and trained in real time during operation of part assembly machine 100. For example, the AI learning module may update and train the controller 120 in real time during operation of the vision inspection station 110.

The vision inspection station 110 includes a part manipulator 200 for moving the parts 10, such as from the parts feeder 102 to the processing machine 40, based on the inspection results. For example, the part manipulator 200 may pick up the parts 10 from the pick station (for example, the parts feeder 102) and place the parts 10 at the place station 44 (for example, the processing machine 40), such as for assembly. The part manipulator 200 may be used to assemble the parts 10 into a product. For example, the parts 10 may be grommets configured to be assembled into housings. In an exemplary embodiment, the part manipulator 200 may be a multi-axis robot manipulator configured to pick the parts off of the parts feeder 102 and move the parts 10 in three-dimensional space. In an exemplary embodiment, the part manipulator 200 may include retractable pins used to pick up and hold the parts 10. For example, the retractable pins may be plugged into openings in the parts 10 and hold the parts 10 by an interference fit. The pins are retracted from the parts 10 at the place station 44 to release the parts 10 from the part manipulator 200.

FIG. 2 is a top view of the part assembly machine 100 in accordance with an exemplary embodiment. The part assembly machine 100 includes the parts feeder 102, the vision inspection station 110, the controller 120, and the part manipulator 200.

In an exemplary embodiment, the parts feeder 102 includes a platform 104 and a part feeding device 106. The parts 10 are loaded onto the platform 104 by the part feeding device 106, which may include a hopper, a conveyor, a robot, or another type of feeding device. The parts 10 are presented to the inspection station 110 on the platform 104. The parts 10 may be advanced or fed along the platform 104, such as by vibration of the platform 104. The parts 10 are removed from the platform 104 by the part manipulator 200. The platform 104 may include a plate having an upper surface 108 used to support the parts 10. The platform 104 may be a vibration tray that is vibrated to advance the parts 10. The platform 104 may be rectangular. However, the platform 104 may have other shapes in alternative embodiments, such as a round shape.

The inspection station 110 includes one or more imaging devices 112 (a single imaging device 112 is illustrated in FIG. 2) arranged adjacent the platform 104. The imaging device 112 may be located above the upper surface 108 and view the parts 10 arranged on the upper surface 108. The imaging device 112 may be a camera, such as a visible light camera, an infrared camera, and the like. The field of view of the imaging device 112 may include the entire surface of the platform 104. The imaging device 112 may be mounted to a position manipulator 114 for moving the imaging device 112 relative to the platform 104. The position manipulator 114 may be an arm or a bracket that supports the imaging device 112. In various embodiments, the position manipulator 114 may be positionable in multiple directions, such as in two-dimensional or three-dimensional space. The position manipulator 114 may be automatically adjusted, such as by the controller 120, to control positioning of the position manipulator 114. In other various embodiments, the position manipulator 114 may be manually adjusted. The position of the imaging device 112 may be adjusted based on the types of parts 10 being imaged. For example, when a different type of part 10 is being imaged, the imaging device 112 may be moved based on the type of part being imaged.

The part manipulator 200 is positioned adjacent the platform 104. The part manipulator 200 is used to pick up the parts 10 that are in a particular orientation(s) (picking orientation(s)) based on input from the imaging device 112. In an exemplary embodiment, the part manipulator 200 includes a robot arm 210 and an end effector 220 at a distal end 212 of the robot arm 210. The end effector 220 may be a mechanical gripper or vacuum gripper configured to pick up the part 10. In various embodiments, the robot arm 210 is a four-axis robot arm or a six-axis robot arm. Other types of robot arms may be used in alternative embodiments. The parts 10 are picked up off of the platform 104 by the end effector 220. In various embodiments, the part manipulator 200 is operated to remove some or all of the parts 10 that are in a particular orientation, such as in a picking orientation. In an exemplary embodiment, the part manipulator 200 is operated to change the orientation of the parts 10 after the parts 10 are picked up to orient the parts in a predetermined orientation, such as a placing orientation (different than the picking orientation), that is a desired orientation for assembly. After all of the parts 10 in the picking orientation are removed, the parts feeder 102 may be operated to change the orientations of the remaining parts 10, such as vibrating the platform 104 to change the orientations of the parts 10. The part manipulator 200 is then operated again to pick up the newly oriented parts 10 that are in the picking orientation.

The controller 120 includes one or more processors 122 for processing the images. The controller 120 is operably coupled to the imaging device 112 and the part manipulator 200 for controlling operation of the part manipulator 200. The imaging device 112 communicates with the controller 120 through machine vision software to process the data, analyze results, record findings, and make decisions based on the information. The controller 120 provides consistent and efficient inspection automation. The controller 120 determines the orientations of the parts 10 to determine which parts 10 are ready to be picked and placed by the part manipulator 200. The controller 120 controls operation of the part manipulator 200 based on the identified locations (x, y, z) and orientations (for example, heading and facing directions) of the parts 10. The controller 120 includes a communication module 124 for communicating with the various components of the part assembly machine 100. The communication module 124 may communicate via wired connections or wireless communication. In an exemplary embodiment, the controller 120 includes a user interface 126. The user interface 126 includes a display, such as a monitor. The user interface 126 includes one or more inputs, such as a keyboard, a mouse, buttons, and the like. An operator is able to interact with the controller 120 with the user interface 126.

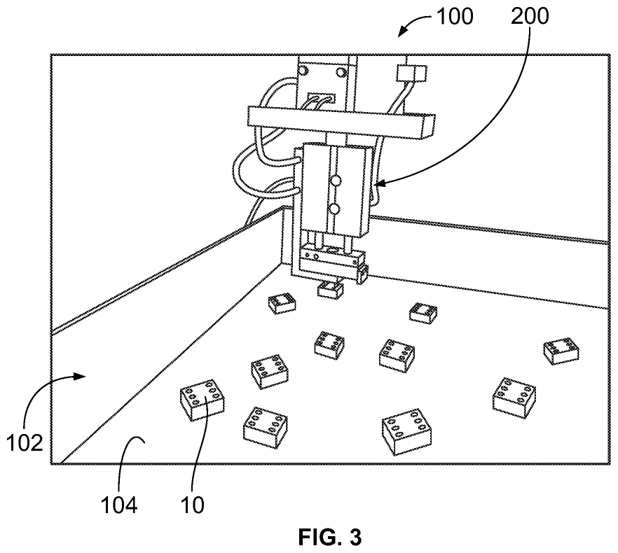

FIG. 3 is a perspective view of the part assembly machine 100 in accordance with an exemplary embodiment showing a plurality of the parts 10 on the parts feeder 102. The part manipulator 200 is shown picking up one of the parts 10. The parts 10 are randomly arranged on the platform 104 at various positions and in various orientations. The orientation of each part is determined by determining a heading direction of the part (angular orientation of the longitudinal axis of the part relative to a datum (for example, end) of the platform 104 of the parts feeder 102) and the facing direction of the part (the surface of the part that is resting on the platform of the parts feeder). For example, the facing direction may be a top facing direction (top resting on the platform 104), a bottom facing direction (bottom resting on the platform 104), a front facing direction (front resting on the platform 104), a rear facing direction (rear resting on the platform 104), a first side facing direction (first side resting on the platform 104), a second side facing direction (second side resting on the platform 104), and the like. The part manipulator 200 picks up the parts 10 identified to be in the picking orientation (for example, top facing direction or bottom facing direction).

In an exemplary embodiment, for efficient part picking, the part manipulator 200 is configured to pick up the parts in a certain orientation, also referred to as a picking orientation. The picking orientation may be the orientation with the openings facing upward for access by the part manipulator 200. Other parts, which are in other orientations, are ignored by the part manipulator 200. Once all of the parts 10 in the picking orientation are removed, the platform 104 is vibrated to change the orientations of the remaining parts 10, causing new orientations. The parts 10 then in the picking orientation are targeted by the part manipulator 200 for picking and placing.

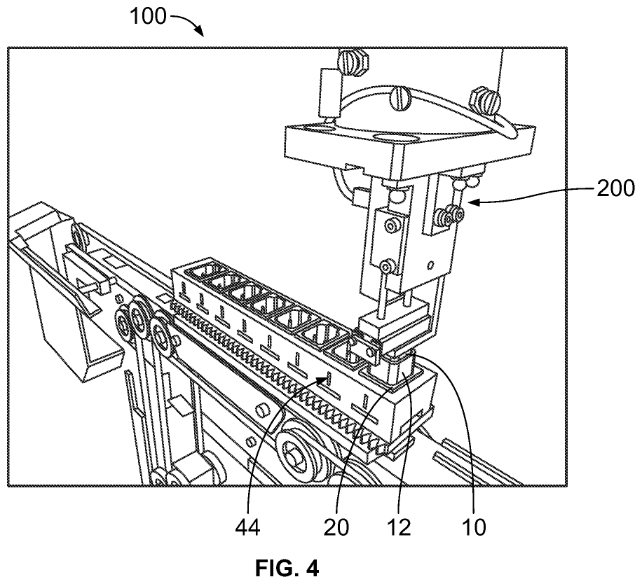

FIG. 4 is a perspective view of the part assembly machine 100 in accordance with an exemplary embodiment showing the part manipulator 200 loading the part 10 into a connector housing 12 of an electrical connector. The connector housing 12 is held in a fixture 20 at the place station 44. The part 10 is plugged into the connector housing 12 from above. After the part 10 is placed in the connector housing 12, the part manipulator 200 may release the part 10 and return to the parts feeder 102 (shown in FIG. 3) to retrieve another part 10.

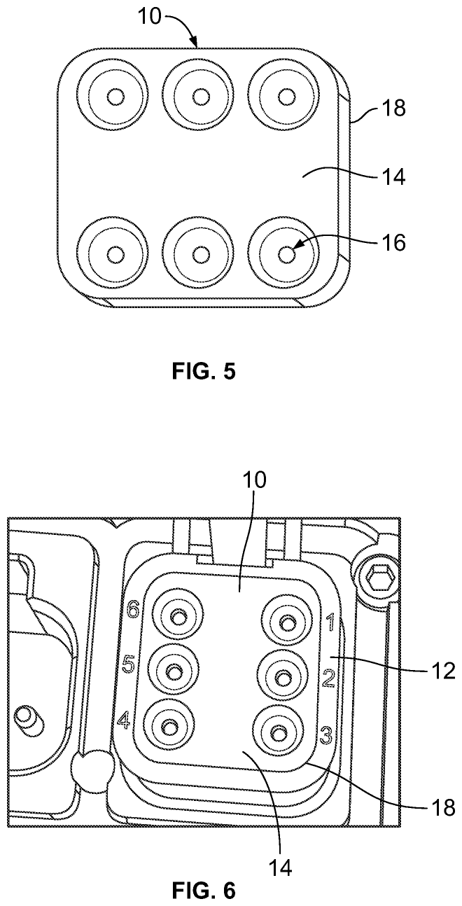

FIG. 5 illustrates an example of the part 10 in the picking orientation (for example, face-up or face-down). In the illustrated embodiment, the part 10 is a grommet or connector seal 14 for the electrical connector. The grommet 14 includes openings 16 that receive contacts and/or wires. The grommet 14 may be sealed to the contacts and/or the wires. The grommet 14 includes one or more sealing ribs 18 around the outer perimeter of the grommet 14. The sealing ribs may be sealed to the connector housing 12. In an exemplary embodiment, the grommet 14 is manufactured from a polymer material, such as a silicon rubber material. In an exemplary embodiment, the grommet 14 is ductile. For example, the grommet 14 is elastic and flexible. In an exemplary embodiment, when the contacts or wires or pressed into the openings 16, the grommet 14 may expand and seal against the contacts or wires by an interference fit.

In an exemplary embodiment, the grommet 14 is generally parallelepiped (for example, box-shaped) having six faces (for example, four sides, a top and a bottom). The top and bottom faces may be identical. The openings 16 extend through the grommet 14 between the top and the bottom. In an exemplary embodiment, the part manipulator 200 uses the openings 16 to pick up the grommet 14. For example, the part manipulator 200 includes pins configured to be plugged into the openings 16 to pick up the grommet 14. The pins flex the grommet 14 around the openings 16 to squeeze onto the pins and retain the grommet 14 on the pins during the pick and place operations.

FIG. 6 is a top perspective view of the part 10 loaded into the connector housing 12. The connector housing 12 includes a cavity that receives the part 10. The part 10 is loaded into the cavity by the part manipulator 200 (shown in FIG. 3). In an exemplary embodiment, the sealing ribs 18 around the outer perimeter of the grommet 14 engage the connector housing 12 by an interference fit and retain the grommet 14 in the cavity. The part manipulator 200 releases from the part 10 after the part 10 is loaded into the connector housing 12.

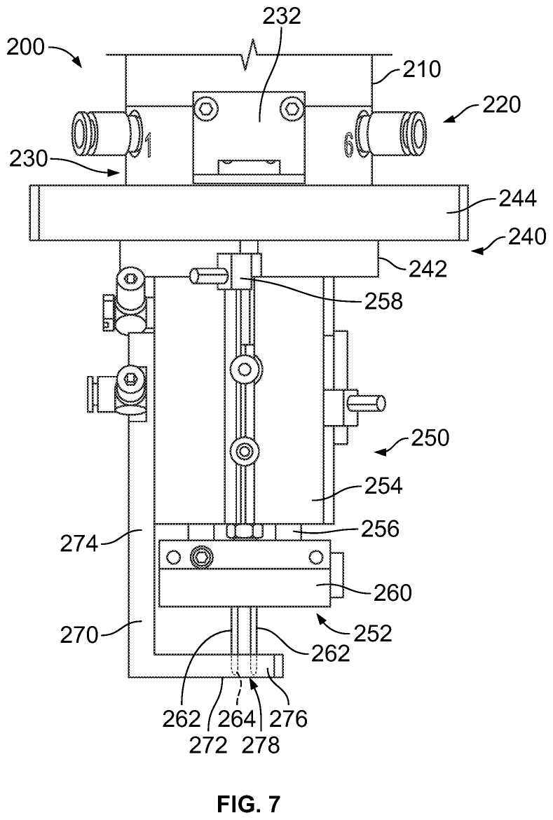

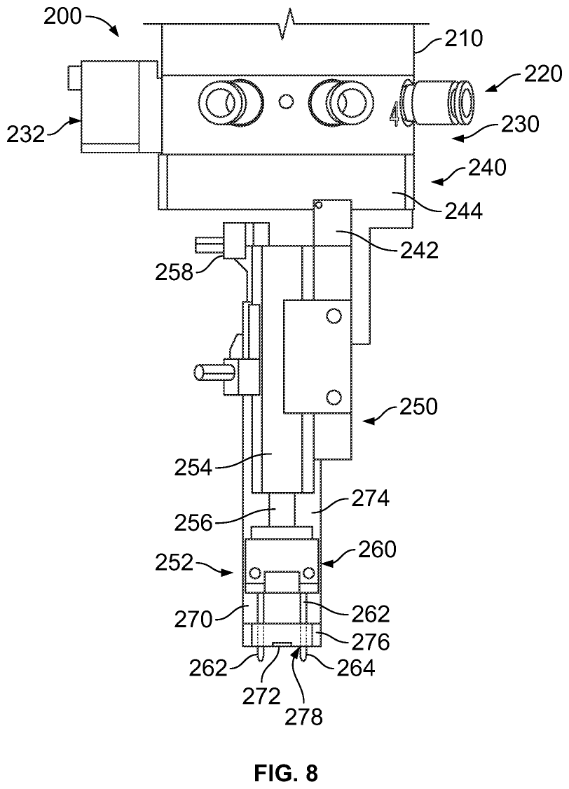

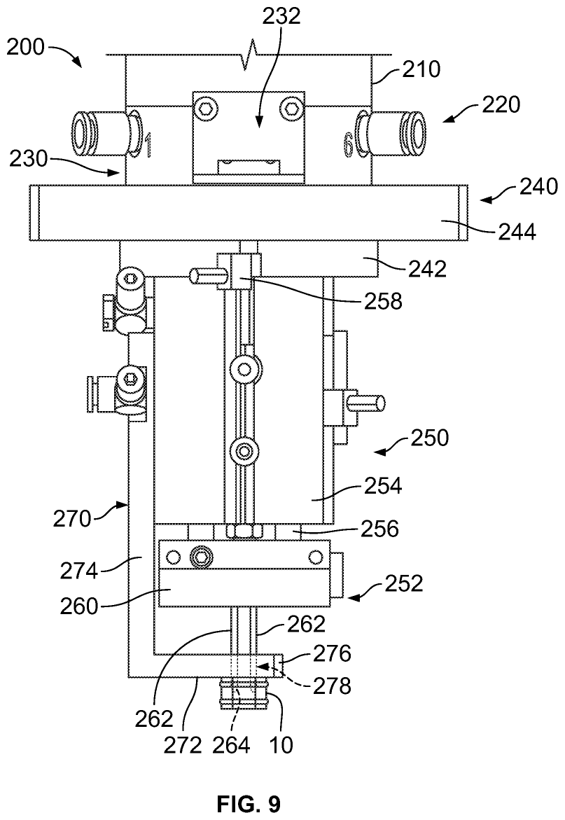

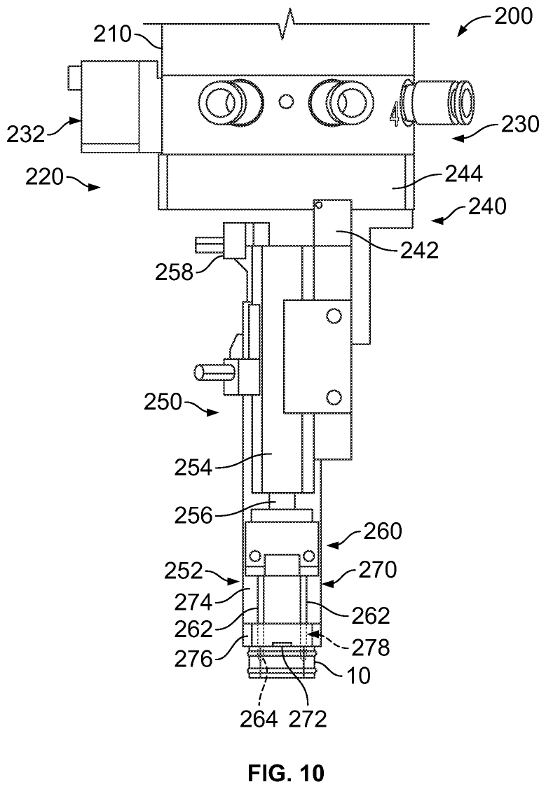

FIG. 7 is a front view of a portion of the part manipulator 200 in accordance with an exemplary embodiment. FIG. 8 is a side view of a portion of the part manipulator 200 in accordance with an exemplary embodiment. FIG. 9 is a front view of a portion of the part manipulator 200 in accordance with an exemplary embodiment. FIG. 10 is a side view of a portion of the part manipulator 200 in accordance with an exemplary embodiment. FIGS. 7-10 illustrate the end effector 220 provided at the distal end 212 of the robot arm 210. FIGS. 7 and 8 show the end effector 220 without one of the parts 10. FIGS. 9 and 10 show the end effector 220 holding one of the parts 10.

In an exemplary embodiment, the end effector 220 includes a rotation platform 230 and a pin gripper 250 coupled to the rotation platform 230. The rotation platform 230 is mounted to the end of the robot arm 210. The end effector 220 is moved in three-dimensional space by the robot arm 210. In an exemplary embodiment, the end effector 220 includes a mounting bracket 240 to mount the pin gripper 250 to the rotation platform 230. In the illustrated embodiment, the mounting bracket 240 includes a mounting base 242 mounted to the rotation platform 230 and a mounting plate 244 used to support the components of the pin gripper 250. In various embodiments, the mounting plate 244 and the mounting base 242 are manufactured from a metal material, such as steel. The mounting plate 244 and the mounting base 242 may be machined to include openings, slots, or other features used to support the components of the pin gripper 250, such as fasteners. The mounting base 242 may be secured to the rotation platform 230 using bolts, latches, clips, or other mounting features.

The rotation platform 230 is operated to rotate the pin gripper 250 relative to the robot arm 210. An actuator is used to rotate the rotation platform 230. The rotation platform 230 may be able to rotate 360°. In other embodiments, the rotation platform 230 may rotate less than 360°, such as 180°. In an exemplary embodiment, the actuator is a pneumatic actuator operated to rotate the rotation platform 230. In other various embodiments, the actuator is an electric actuator having a shaft used to rotate the rotation platform 230. Other types of actuators may be used in alternative embodiments. In an exemplary embodiment, the rotation platform 230 may include a rotation stop used to control or stop rotation of the rotation platform 230. In an exemplary embodiment, the rotation platform 230 includes a rotation platform sensor 232 used to determine an angular position of the rotation platform 230, and thus to determine an orientation of the pin gripper 250. Signals from the rotation platform sensor 232 may be used to verify the position of the rotation platform 230 for picking and placing the parts 10.

The end effector 220 may be provided without the rotation platform 230 in alternative embodiments. For example, the mounting bracket 240 may be mounted directly to the end of the robot arm 210. The robot arm 210 is used to control the orientation of the pin gripper 250 in such embodiments rather than the rotation platform 230.

In an exemplary embodiment, the pin gripper 250 is used to mechanically pick up and hold the part 10, such as for movement of the part 10 from the parts feeder 102 to the placing station 44. The pin gripper 250 is coupled to the rotation platform 230 by the mounting bracket 240. The mounting bracket 240 and the pin gripper 250 are rotatable with the rotation platform 230, such as to orient the pin gripper 250 to pick up the part 10.

The pin gripper 250 includes a pin assembly 252 and a pin actuator 254 operated to move the pin assembly 252 to pick up and release the part 10 from the pin gripper 250. The pin actuator 254 is coupled to the mounting bracket 240, such as to the mounting plate 244. The pin actuator 254 is a pneumatic actuator movable in a linear actuation direction (for example, vertical actuation direction). The pin actuator 254 includes one or more drive rods 256 coupled to the pin assembly 252. The pin actuator 254 is operated to move the drive rods 256, which in turn move the pin assembly 252. In Other types of actuators may be used in alternative embodiments, such as an electric actuator having a shaft that is rotated to move the pin assembly 252. For example, the shaft may be threadably coupled to the pin assembly 252 to move the pin assembly 252. In an exemplary embodiment, the pin gripper 250 includes a sensor 258 used to determine a position of the pin assembly 252. Signals from the sensor 258 are used to verify the position of the pin assembly 252 for picking and placing the parts 10. The robot arm 210 may be controlled based on input from the sensor 258.

In an exemplary embodiment, the pin assembly 252 includes a pin holder 260 holding at least one pin member 262. Each pin member 262 extends to a distal end 264. The distal end 264 of the pin member 262 is configured to be plugged into the part 10 (for example, into the openings 16, to pick up the part 10. The pin member 262 is movable with the pin holder 260. For example, the pin actuator 254 is operated to move the pin holder 260, which in turn moves the pin member 262.

In the illustrated embodiment, the pin assembly 252 includes a pair of the pin members 262 (for example, a first pin member and a second pin member). The pin actuator 254 moves the pin members 262 in a linear actuation direction between a retracted position (FIG. 7) and an extended position (FIG. 8). In an exemplary embodiment, the pin members 262 are movable vertically between the retracted position and the extended position. For example, the pin members 262 are moved downward from the retracted position to the extended position and are moved upward from the extended position to the retracted position.

In an exemplary embodiment, the end effector 220 includes a part support fixture 270 sued to support the part 10 during the pick and place process. In the illustrated embodiment, the part support fixture 270 is coupled to the pin actuator 254. However, the part support fixture 270 may be coupled to the mounting bracket 240 in alternative embodiments. The part support fixture 270 includes a support surface 272 for supporting and positioning the part 10 relative to the end effector 220. In an exemplary embodiment, the support surface 272 is a bottom surface of the part support fixture 270. The part 10 is configured to be held below the part support fixture 270. For example, the pin assembly 252 may lift the part 10 upward against the support surface 272 of the part support fixture 270. The part support fixture 270 may be used to press the part 10 downward into the connector housing 12 at the place station 44 during the placing process.

In an exemplary embodiment, the part support fixture 270 is L-shaped including a main body 274 and a support body 276 extending from the main body 274. The main body 274 is coupled to the pin actuator 254. For example, the main body 274 may be secure to the pin actuator 254 using fasteners. The main body 274 may extend vertically in various embodiments. The main body 274 extends to a location below the pin actuator 254 and the pin holder 260. In an exemplary embodiment, the support body 276 extends from a bottom of the main body 274. The support body 276 may extend generally perpendicular from the main body 274, such as generally horizontally. The support body 276 includes the support surface 272 at a bottom of the support body 276. The support body 276 supports the part from above.

In an exemplary embodiment, the part support fixture 270 includes pin openings 278 that receive the pin members 262. In the illustrated embodiment, the pin openings 278 pass through the support body 276. The pin members 262 are movable relative to the part support fixture 270. For example, the pin members 262 move between the retracted position and the extended position. In an exemplary embodiment, the distal ends 264 of the pin members 262 extend from the part support fixture 270 in the extended position (FIG. 7) to engage and hold the part 10 against the part support fixture 270 in the extended position. For example, the pin members 262 extend below the bottom of the support body 276 in the extended position and are thus able to interface with the part 10 when the end effector 220 is pressed onto the part at the pick station. The pin members 262 are configured to pick up the part 10 in the extended position by loading the distal ends 264 into the openings 16 and engaging the part 10 by an interference fit. The pin members 262 hold the part 10 against the support surface 272 during transportation by the robot arm 210 from the pick station to the place station. The pin members 262 are configured to be retracted from the part 10 when the pin members 262 are moved to the retracted position. For example, the part 10 is held by the support body 276 and the support body 276 blocks the part 10 from moving upward as the pin members 262 are retracted from the part 10. The part 10 is released from the pin gripper 250 when the pin members 262 are retracted. For example, the pin actuator 254 is configured to release the part 10 at the place station (for example, in the connector housing 12) when the pin members 262 are moved to the retracted position. The support body 276 supports the part 10 from moving with the pin members 262 when the pin members 262 are moved from the extended position to the retracted position to release the part 10 from the pin gripper 250.

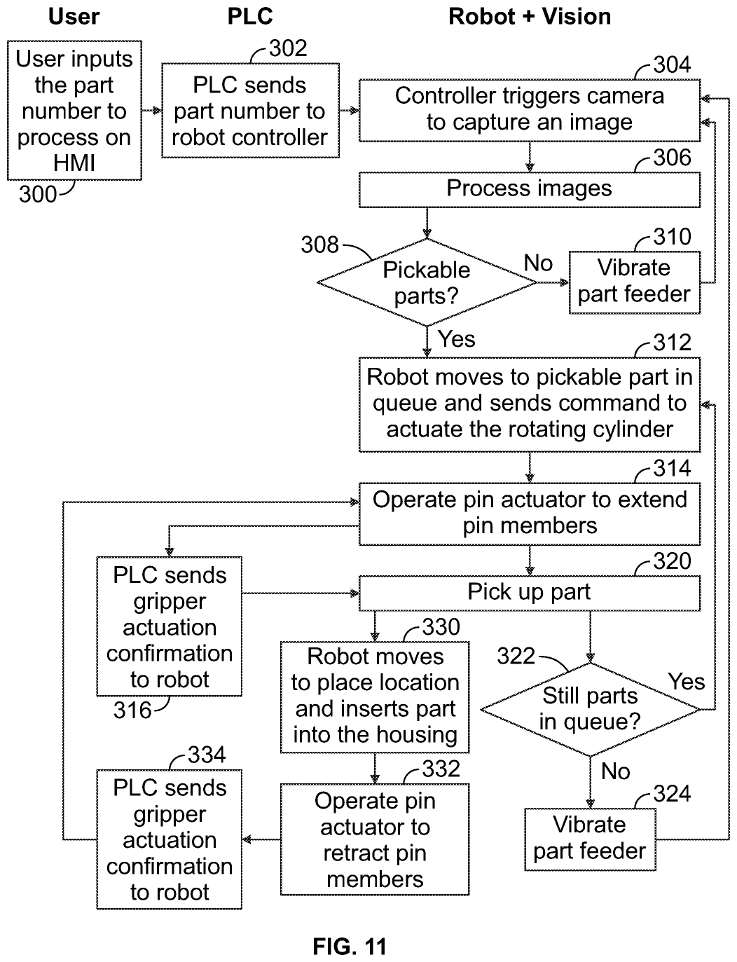

FIG. 11 is a flow chart showing a method of assembling parts in accordance with an exemplary embodiment. The method, at 300, includes inputting the part numbers or type of parts being assembled by the part assembly machine. The user may manually enter the part numbers or select the type of parts being assembled, such as into a user interface of the part assembly machine. The parts are loaded onto the platform of the parts feeder.

At 302, the method includes sending control signals to the part manipulator based on the type of parts being assembled. The control signals control positioning of the part manipulator relative to the platform. For example, the control signals control the vertical positioning of the part manipulator (for example, the end effector of the part manipulator) for picking up the parts based on the type of parts being assembled.

At 304, the controller triggers the imaging device to capture an image of the parts on the platform of the parts feeder. At 306, the controller processes the images. The image is analyzed by the controller to determine orientations of each of the parts (for example, top orientations, bottom orientations, front orientations, rear orientations, first side orientations, second side orientations, and the like). The imaging may be performed quickly and efficiently using the imaging device. The image may be processed using an image analysis model, which is based on the type of parts being assembled. The image analysis model may include a shape recognition tool to determine locations and orientations of the parts. In various embodiments, the images are processed by performing pattern recognition of the images based on the image analysis model. In various embodiments, the images are processed by performing feature extraction of boundaries and surfaces detected in the images and comparing the boundaries and surfaces to the image analysis model. The orientation of each part is determined by determining a heading direction of the part (angular orientation of the longitudinal axis of the part relative to a datum (for example, end) of the platform of the parts feeder) and the facing direction of the part (the surface of the part that is resting on the platform of the parts feeder).

At 308, the controller determines if there are any pickable parts based on the image analysis. The pickable parts are the parts that are in a predetermined orientation, namely a picking orientation. The picking orientation is based on the type of parts being assembled. In various embodiments, the parts may have a single picking orientation (for example, a bottom orientation). However, in other various embodiments, the parts may have multiple picking orientations (for example, a top orientation and a bottom orientation). The controller determines the number of parts in the picking orientation and determines the locations of the parts in the picking orientation. At 310, if there are no pickable parts, the controller sends a signal to the parts feeder to vibrate the parts feeder to flip the parts on the platform and change the orientations of the parts on the platform. After the parts feeder is vibrated, the method returns to step 304 to trigger the camera to capture another image.

At 312, if there are pickable parts, the controller queues the positions (x, y, z) and the orientations (heading direction, facing direction) of each of the pickable parts to the parts manipulator and moves the part manipulator to the first part in the queue. At 314, the controller causes the pin actuator to actuate to move the pin members to the extended positions. The pin members are extended to position the distal ends of the pin members below the support surface of the part support fixture. The sensor sends a confirmation signal to the controller of the position of the pin members in the extended position. When the sensor signal is received, at 316, the controller sends a confirmation signal to the part manipulator. The pin members may be free to move from the retracted position to the extended position even as the robot arm is moving. As such, the pin actuation may be performed on-the-fly as the robot arm is moving to the pick-up location. The on-the-fly actuation reduces the overall assembly time.

At 320, after the pin members are extended and the confirmation signal is received by the part manipulator, the controller moves the part manipulator for part pick-up. The controller causes the robot arm to move to a pick-up staging position. The pick-up staging position may be aligned vertically above the part. The part manipulator moves the part support fixture into engagement with the part. For example, the support surface of the part support fixture may be pressed downward against the part. The pin members are moved downward into the openings in the part to engage the part by an interference fit. The part is ductile to expand when the pin members are pressed into the openings. After the part is picked up, at 322, the controller determines if there are additional parts in the queue. If parts are still in the queue, the process returns to step 312 to pick up the next part. If there are no more parts in the queue, the controller causes the part feeder to vibrate at step 324 to change the orientations of the parts on the part feeder. The process then returns to step 304 to image the parts.

At 330, after the part is picked up, the controller causes the part manipulator to move to the place station. The robot arm moves to the place station to a location vertically above the connector housing. The robot arm presses the part into the connector housing. At 332, the controller operates the pin actuator to retract the pins. The pin actuator is actuated to move the pin members to the retracted positions. The pin members are removed from the part. The part support fixture holds the part downward in the connector housing as the pin members are retracted from the part. At 334, the controller sends a confirmation signal to the part manipulator that the pin members are in the retracted position. The process may continue until all of the parts have been assembled.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A part manipulator comprising:
a robot arm movable in three-dimensional space, the robot arm movable between a pick station and a place station;
an end effector coupled to a distal end of the robot arm, the end effector including a part support fixture and a pin gripper adjacent the part support fixture, the pin gripper including a pin member and a pin actuator operated to move the pin member between a retracted position and an extended position, a distal end of the pin member extending from the part support fixture in the extended position to engage and hold a part against the part support fixture in the extended position, wherein the pin member is configured to pick up the part in the extended position at the pick station, and wherein the pin actuator is configured to release the part at the place station when the pin member is moved to the retracted position.

2. The part manipulator of claim 1, wherein the pin member is retractable relative to the part support fixture.

3. The part manipulator of claim 1, wherein the part support fixture includes a pin opening therethrough, the pin member received in the pin opening, the pin member movable relative to the part support fixture within the pin opening.

4. The part manipulator of claim 1, wherein the pin member is a first pin member, the pin gripper further comprising a second pin member movable between a retracted position and an extended position.

5. The part manipulator of claim 1, wherein the pin member is pluggable into an opening in the part to pick up the part.

6. The part manipulator of claim 1, wherein the pin support fixture includes a support surface at a bottom of the pin support fixture, the pin member holding the part against the support surface.

7. The part manipulator of claim 6, wherein the support surface supports the part from moving with the pin member when the pin member is moved from the extended position to the retracted position to release the part from the pin gripper.

8. The part manipulator of claim 1, wherein the pin actuator moves the pin member in a linear actuation direction between the retracted position and the extended position.

9. The part manipulator of claim 1, wherein the end effector further comprises a rotation platform rotatable relative to the robot arm to change an angular orientation of the part.

10. The part manipulator of claim 1, wherein the part support fixture is L-shaped including a main body and a support body extending from the main body, the support body including a support surface at a bottom of the support body, the support surface supporting the part from above, the pin member holding the part against the support surface when in the extended position, the pin member being retractable into the support body when moved to the retracted position to release the part from the pin gripper.

11. The part manipulator of claim 1, wherein the end effector includes a pin sensor detecting a position of the pin member, the robotic arm being controlled based on input from the pin sensor.

12. A part assembly machine comprising:
a pick station having a part feeder, the part feeder having a platform supporting parts;
a vision inspection station positioned adjacent the part feeder, the vision inspection station including an imaging device to image the parts in a field of view above the platform;
a controller receiving images from the imaging device, the controller determining orientations of the parts on the platform from a plurality of possible orientations, the possible orientations including a picking orientation, the controller determining locations of each part in the picking orientation;
a part manipulator positioned adjacent the pick station to successively pick up the parts in the picking orientation from the part feeder, the part manipulator configured to place the parts at a place station, the part manipulator including a robot arm and an end effector coupled to a distal end of the robot arm, the robot arm operably coupled to the controller, the robot arm movable in three dimensional space between the pick station and the place station, the end effector operably coupled to the controller, the end effector including a part support fixture and a pin gripper adjacent the part support fixture, the pin gripper including a pin member and a pin actuator operated to move the pin member between a retracted position and an extended position, a distal end of the pin member extending from the part support fixture in the extended position to engage and hold a part against the part support fixture in the extended position;
wherein the controller operates the robot arm to successively position the end effector proximate to the parts in the picking orientations;
wherein the controller operates the end effector to pick up the corresponding part in the picking orientation at the pick station with the pin member in the extended position;
wherein the controller operates the robot arm to move the end effector to the place station after the part is picked up; and
wherein the controller operates the end effector to release the part at the place station when the pin member is moved to the retracted position.

13. The part assembly machine of claim 12, wherein the pin member is retractable relative to the part support fixture.

14. The part assembly machine of claim 12, wherein the part support fixture includes a pin opening therethrough, the pin member received in the pin opening, the pin member movable relative to the part support fixture within the pin opening.

15. The part assembly machine of claim 12, wherein the pin member is a first pin member, the pin gripper further comprising a second pin member movable between a retracted position and an extended position.

16. The part assembly machine of claim 12, wherein the pin support fixture includes a support surface at a bottom of the pin support fixture, the pin member holding the part against the support surface, the support surface supporting the part from moving when the pin member is moved from the extended position to the retracted position to release the part from the pin gripper.

17. The part assembly machine of claim 12, wherein the part manipulator picks up only the parts in the picking orientation and does not pick up the parts in other orientations.

18. The part assembly machine of claim 12, wherein the platform of the part feeder is vibrated to change orientations of the parts on the upper surface of the platform, and wherein the imaging device images the parts after vibration to identify orientations of the parts after vibration to identify the parts in the picking orientation.

19. A method of assembling parts comprising:
loading the parts on an upper surface of a platform of a part feeder;
imaging the parts on the platform using an imaging device;
processing images to determine orientations of the parts on the platform from a plurality of possible orientations, the possible orientations including a picking orientation, the controller determining locations of each part in the picking orientation;
successively picking up the parts that are in the picking orientation using a part manipulator including a robot arm movable in three dimensional space and an end effector coupled to a distal end of the robot arm that includes a part support fixture and a pin gripper adjacent the part support fixture, the pin gripper including a pin member and a pin actuator operated to move the pin member between a retracted position and an extended position, a distal end of the pin member extending from the part support fixture in the extended position to engage and hold a part against the part support fixture in the extended position;
operating the robot arm to move the end effector and the part to a place station; and
operating the pin actuator to move the pin member to the retracted position to release the part at the place station.

20. The method of claim 19, further comprising retracting the pin member into the part support fixture to release the part from the pin gripper, the support surface supporting the part from moving when the pin member is moved from the extended position to the retracted position.
